(19) United States
(12) Patent Application Publication
(10) Pub. No.: US 2022/0010444 A1
(43) Pub. Date: Jan. 13, 2022

(54) METHOD FOR CHANGING THE OPERATING MODE OF AN ELECTROLYSIS SYSTEM, AND ELECTROLYSIS SYSTEM

(71) Applicant: Linde GmbH, Pullach (DE)

(72) Inventors: Thomas CICHY, Eberbach (DE); Andreas PESCHEL, Wolfratshausen (DE); Benjamin HENTSCHEL, München (DE)

(21) Appl. No.: 17/294,552

(22) PCT Filed: Nov. 5, 2019
(86) PCT No.: PCT/EP2019/025378

§ 371 Date: May 17, 2021

(30) Foreign Application Priority Data
Nov. 22, 2018 (DE) 10 2018 009 198.9

(51) Int. Cl. C25B 15/08; B01D 53/22; C25B 9/17; C25B 1/23

(52) U.S. Cl. CPC C25B 15/083; C25B 1/23; C25B 9/17; B01D 53/229

(57) ABSTRACT

A device comprising an electrolyser, a compressor, and a membrane separating device, and to a method for changing the operating mode between normal and standby operation of said device, in the normal operation of which an electrolysis raw product comprising carbon dioxide is converted in the electrolyser into an electrolysis product containing carbon dioxide and carbon monoxide, at least one portion of which is conducted via the compressor and is fed at an increased pressure to the membrane separating device in order to obtain a retentate which is enriched in carbon monoxide and depleted of carbon dioxide compared with the electrolysis product. According to the invention, in order to change from the normal operation into the standby operation, the electrolyser is completely isolated from the membrane separating device in terms of flow and then shut down, wherein the pressure ratios in the membrane separating device are largely maintained.

The invention relates to a method for changing the operating mode of a device comprising an electrolyzer, a compressor, and a membrane separating device between normal and standby operation, wherein, during normal operation of the device, an electrolysis raw product comprising carbon dioxide is converted in the electrolyzer into an electrolysis product containing carbon dioxide and carbon monoxide, at least one portion of which product is conducted via the compressor and is fed at an increased pressure to the membrane separating device in order to obtain a retentate which is enriched in carbon monoxide and depleted of carbon dioxide, compared with the electrolysis product.

The invention further relates to a device which can be operated according to the method according to the invention.

A retentate is understood by the person skilled in the art to mean those constituents of a gas mixture that are retained by a membrane used for separating the gas mixture. The membrane separating device used in the context of the present invention is designed with at least one membrane which preferably allows carbon dioxide to pass and retains carbon monoxide. A gas or gas mixture is thereby obtained as retentate, which gas or gas mixture is depleted of carbon dioxide, compared with the electrolysis product used.

Accordingly, a permeate consists of the constituents of the gas mixture to be separated which are not retained by the membrane used for separation. The permeate considered in the context of the present invention is enriched in carbon dioxide and depleted of carbon monoxide, compared with the electrolysis product.

Depending upon the gas or gas mixture which can be withdrawn from it, one side of a membrane or membrane separating device that can be used to separate a gas mixture is referred to as the retentate or permeate side.

Devices of the generic type are used for generating carbon monoxide or synthesis gas, wherein, in the electrolyzer, carbon dioxide is electrochemically converted—alone or together with water—to an electrolysis product, which contains not only carbon monoxide or carbon monoxide and hydrogen, but also unconverted carbon dioxide that has to be separated off in a downstream membrane separating device in order to obtain carbon monoxide or synthesis gas. The membrane separating device has at least one membranes, selectively permeable to carbon dioxide, via which a CO₂ partial pressure difference is generated. The selectivity of the membrane used results from different diffusion rates of the components of the gas mixture to be separated. Corresponding polymer membranes are currently used commercially.

The principles of the reactions taking place in the electrolyzer are described below using the example of co-electrolysis of water and carbon dioxide. However, instead of co-electrolysis of water and carbon dioxide, pure carbon dioxide electrolysis, in particular, can also be used in the context of the present invention. It goes without saying that, here, the reaction equations relating to water electrolysis do not apply or that corresponding reactions do not take place. However, a separate explanation is omitted for the sake of clarity.

Depending upon the electrolyte and catalyst used, there are different embodiments of co-electrolysis which differ, in particular, in terms of the operating temperature and the electrochemical reactions occurring at the electrodes of the electrolyzer.

An electrolyzer with a proton exchange membrane is used to carry out the so-called low-temperature co-electrolysis. In this case, the following cathode reactions take place:

CO₂+2e⁻+2H⁺→CO+H₂O (1)

2e⁻2H⁺→H₂ (2)

According to the equation,

H₂O→½O₂+2H⁺-2e⁻ (3)

water is decomposed at the anode.

In variants of corresponding methods, instead of protons, other positive charge carriers, such as the ions of an electrolyte salt, can be formed at the anode, transported via a appropriately designed membrane, and reacted at the cathode. An example of an electrolyte salt is potassium hydroxide. In this case, the positive charge carriers are potassium ions. Further variants include, for example, the use of anion exchange membranes. In all variants, however, the transport of the charge carriers does not, as in the solid oxide electrolysis cells explained below, take place in the form of oxygen ions, but rather in the form of the charge carriers explained. For details, see, for example, Delacourt et al. (2008), J. Electrochem. Soc. 155(1), B42B49, DOI: 10.1149/1.2801871.

The protons or other corresponding charge carriers are selectively transferred from the anode side to the cathode side via a membrane. Depending upon the catalyst selected, the respective formation reactions then compete at the cathode, such that synthesis gases with different hydrogen-to-carbon monoxide ratios are obtained. Depending upon the embodiment of the catalyst used, other useful products may also be formed during low-temperature co-electrolysis.

During high-temperature co-electrolysis, which is carried out using solid oxide electrolysis cells, the following cathode reactions are observed or postulated:

CO₂+2e⁻→CO+O²⁻ (4)

H₂O+2e⁻→H₂+O²⁻ (5)

Furthermore, the following reaction takes place at the anode:

2O²⁻→O₂+4e⁻ (6)

Here, the oxygen ions are, essentially, selectively led from the cathode to the anode via a ceramic membrane.

It is not completely clear whether the reaction according to reaction equation 4 takes place in the manner described. Possibly, only hydrogen is formed electrochemically, while carbon monoxide is formed by reverse water-gas shift reaction in the presence of carbon dioxide:

CO₂+H₂⇄H₂O+CO (7)

Normally, the gas mixture obtained during high-temperature co-electrolysis is (or is approximately) in water-gas shift equilibrium. However, the specific manner in which the carbon monoxide is formed has no effect on the present invention.

Normally, neither high-temperature nor low-temperature co-electrolysis result in a complete conversion of carbon dioxide and water, which is why the electrolysis product withdrawn at the cathode contains carbon dioxide.

Because of the comparatively low investment costs, the electrolysis methods described with downstream, membrane-based carbon dioxide separation can, in particular, be used advantageously when small or medium amounts of carbon monoxide or synthesis gas are to be produced on-site for a consumer. Often, however, precisely with such applications, high demands are placed on the flexibility of the system, because either the dispensable product amounts vary widely in terms of time, such as when the consumer is operated in a batch process, or if the price advantages are to be optimally utilized in the fluctuating electricity market. Low-temperature electrolyses are particularly suitable for flexible use because their mode of operation can be changed very quickly between normal and standby operation. However, since the differential pressure across the membranes must be set much slower to avoid damage, the known concepts for electrolytic carbon monoxide or synthesis gas extraction are characterized by the long up and down times of the membrane separating devices used for carbon dioxide separations, which greatly limit the flexibility of the overall process. If, on short notice, no carbon monoxide or synthesis gas can be delivered to the consumer, normal operation is therefore, according to the prior art, maintained, and the amount of product which cannot be dispensed is discarded, at an economic loss.

The aim of the present invention is therefore to provide a method and a device of the type described in the introduction which are suitable for producing the amount of retentate depleted of carbon dioxide more economically than in the prior art, and with high flexibility.

The aim is achieved according to the invention by a method where, in order to change from normal to standby operation, the electrolyzer is completely isolated from the membrane separating device in terms of flow and then shut down, wherein the pressure ratios in the membrane separating device are largely maintained.

The fact that the pressure ratios are largely maintained in the membrane separating device is to be understood to mean that the differential pressure across every membrane of the membrane separating device, while the sign remains constant, changes only slowly and preferably deviates by no more than 30%—and particularly preferably no more than 15%—from the mean value which the differential pressure has during normal operation. A change in differential pressure is considered to be slow if it takes place at a rate of less than 30%—and preferably less than 15%—per minute, relative to the mean value that the differential pressure has during normal operation. Expediently, the pressure ratios in the membrane separating device are largely maintained not only when changing from normal to standby operation, but also during standby operation itself.

The electrolyzer is completely isolated from the membrane separating device in terms of flow by blocking all lines that connect the electrolyzer directly or via one or more further parts of the device to the membrane separating device. Since the membrane separating device may subsequently no longer be supplied with fresh electrolysis product, isolation in terms of flow would lead to a change in the pressure ratios in the membrane separating device. The membrane device is therefore preferably connected to the compressor, simultaneously with its complete isolation in terms of flow from the electrolyzer, to form a sealed-in system, in which the suction side of the compressor is connected to the permeate side of the membrane separating device via a first line. In order to largely maintain the pressure ratios in the membrane separating device, the pressure side of the compressor or the retentate side of the membrane separating device may be connected to the suction side of the compressor via a second line, in which a control valve coupled to a pressure regulator is arranged.

In order to change from standby operation according to the invention to normal operation, it is provided to first start the electrolyzer and to then completely remove its isolation from the membrane separating device in terms of flow, while largely maintaining the pressure ratios in the membrane separating device.

If the membrane separating device is connected to the compressor in standby operation to form a sealed-in system, said system is, expediently, connected to the already-started electrolyzer in order to change from standby to normal operation, wherein, at the same time, the path for the retentate downstream of the membrane separating device is opened, and the connection of the suction side of the compressor to the permeate side of the membrane separating device is interrupted. The connection existing between the suction side of the compressor and its pressure side or the retentate side of the membrane separating device may also remain intact during normal operation, in order to control the pressure conditions in the membrane separating device.

If the device according to the invention has a mixing device, arranged upstream of the electrolyzer, by means of which the electrolysis raw product is formed from a carbon dioxide-containing raw product and at least one portion of the permeate obtained in the membrane separating device, the fluidic connection between the electrolyzer and the membrane separating device existing via the mixing device is, expediently, interrupted when changing from normal to standby operation of the device, and is opened when changing from standby to normal operation.

The invention further relates to a device having a compressor, a membrane separating device, and an electrolyzer, with which, during normal operation of the device, an electrolysis raw product comprising carbon dioxide can be converted into an electrolysis product containing carbon dioxide and carbon monoxide, at least one portion of which product can be conducted via the compressor and can be fed at an increased pressure to the membrane separating device in order to obtain a retentate which is enriched in carbon monoxide and depleted of carbon dioxide, compared with the electrolysis product.

The aim is achieved according to the invention by the device having an isolation device with at least one valve with which the electrolyzer can be completely isolated from the membrane separating device in terms of flow when changing from normal to standby operation, while largely maintaining the pressure ratios in the membrane separating device.

A preferred embodiment of the device according to the invention provides for the isolation device to comprise several valves as well as a first and a second line for connecting the membrane separating device to the compressor to form a sealed-in system, in which the suction side of the compressor is connected to the permeate side of the membrane separating device via the first line and is connected to the pressure side of the compressor or the retentate side of the membrane separating device via the second line, wherein, in the second line, a control device is arranged, via which the differential pressure between retentate and permeate side of the membrane separating device can be controlled when changing between normal and standby operation.

A further preferred embodiment of the device according to the invention provides for a mixing device, arranged upstream of the electrolyzer and connected to the permeate side of the membrane separating device in terms of flow, in which a raw product containing carbon dioxide can be mixed with at least one portion of the permeate obtained in the membrane separating device to form the electrolysis raw product. A valve, belonging to the isolation device, which is open during normal operation of the device and is closed in standby operation, is, expediently, arranged in the fluidic connection existing between the permeate side of the membrane separating device and the mixing device.

According to the invention, the electrolyzer of the device is a high-temperature or low-temperature electrolyzer designed to electrochemically convert carbon dioxide—alone or together with water—to hydrogen and/or carbon monoxide.

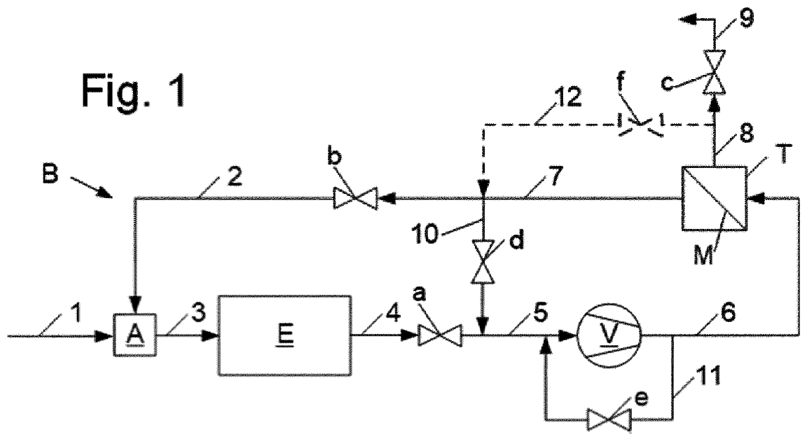

The invention is explained in more detail below using an exemplary embodiment schematically illustrated in FIG. 1.

FIG. 1 shows two preferred embodiments of the device according to the invention, in which the membrane separating device and the compressor can be connected to one another in a first or a second manner when changing between normal and standby operation.

In device B, a carbon dioxide-containing raw product 1 is introduced into mixing device A in normal operation and is there mixed with the recycle stream 2, which is largely composed of carbon dioxide, to form the electrolysis raw product 3, which is then supplied to electrolyzer E. Here, the carbon dioxide contained in electrolysis raw product 3 is reacted—alone or together with water—by high-temperature or low-temperature electrolysis, so that an electrolysis product 4 can be withdrawn from the cathode of electrolyzer E, which consists of carbon dioxide and possibly hydrogen as well as unreacted carbon dioxide. The electrolysis product is supplied via valve a and line 5 to the compressor V, whence it is fed at an elevated pressure into the membrane separating device T via line 6. Although the membrane separating device T is shown with a single membrane M, it may also have several membranes arranged in series or in parallel which are selectively permeable to carbon dioxide. Between the retentate side and the permeate side of each membrane, a pressure difference exists, as a result of which carbon dioxide is separated from the electrolysis product, such that a permeate 7, largely consisting of carbon dioxide, and a retentate 8 depleted in terms of carbon dioxide content compared to the electrolysis product are obtained. The permeate 7 is fed as recycle stream 2 to the mixing device A via valve b, while the permeate 7 is delivered as product 9 to a consumer (not shown) via valve c. Valve d is closed during normal operation, such that nothing flows through line 10. To control the pressure ratios in the membrane separating device T, line 11 (first preferred embodiment) or 12 (first preferred embodiment) contains a control valve e or f that is coupled to a pressure regulator.

In order to change the device from normal to standby operation, the valves a, b, and c are closed via membrane M or membranes M of the membrane separating device T when the compressor V is running, while largely maintaining the differential pressure. At the same time, valve d is opened, such that the permeate side of the membrane separating device T is connected to the suction side of the compressor V via line 10. The membrane separating device T is now connected to the compressor V to form a sealed-in system and is completely isolated from the electrolyzer E in terms of flow, which can therefore be switched off. The pressure ratios in the membrane separating device T are controlled via control valve e or f during switching and for the duration of standby operation.

When wanting to change again from standby to normal operation, valves a, b, and c are opened and valve d is closed, while the pressure ratios in the membrane separating device T are largely maintained via control valve e or f. At the same time, electrolyzer E is started again. If necessary, the retentate stream 8 is discarded or returned to the electrolyzer E until the required product purity is achieved.

1. A method for changing the operating mode of a device comprising an electrolyzer, a compressor, and a membrane separating device between normal and standby operation, wherein, in normal operation of the device, an electrolysis raw product comprising carbon dioxide is converted in the electrolyzer into an electrolysis product containing carbon dioxide and carbon monoxide, at least one portion of which product is conducted via the compressor) and is fed at an increased pressure to the membrane separating device in order to obtain a retentate which is enriched in carbon monoxide and depleted of carbon dioxide, compared with the electrolysis product, wherein, in order to change from normal to standby operation, the electrolyzer is completely isolated from the membrane separating device in terms of flow and then shut down, wherein the pressure ratios in the membrane separating device are largely maintained.

2. The method according to claim 1, wherein, in order to maintain the pressure ratios in the membrane separating device, the compressor is connected to the membrane separating device to form a sealed-in system in terms of flow, in which the suction side of the compressor is connected to the permeate side of the membrane separating device via a first line and is connected to the pressure side of the compressor or the retentate side of the membrane separating device via a second line, wherein the differential pressure between retentate and permeate side is controlled via a control valve arranged in the second line.

3. The method according to claim 1, wherein, in order to change from standby to normal operation, the electrolyzer is started up and its isolation from the membrane separating device in terms of flow is then completely removed, while largely maintaining the pressure ratios in the membrane separating device.

4. The method according to claim 2, wherein, in order to change from standby to normal operation, the system which is sealed-in in terms of flow and comprises the compressor and the membrane separating device is connected to the already-started electrolyzer, wherein, at the same time, the path for the retentate is opened downstream of the membrane separating device, and the direct connections of the suction side of the compressor with and the permeate side of the membrane separating device and the pressure side of the compressor or the retentate side of the membrane separating device are interrupted.

5. A device having a compressor, a membrane separating device, and an electrolyzer, by means of which, during normal operation of the device, an electrolysis raw product comprising carbon dioxide can be converted into an electrolysis product containing carbon dioxide and carbon monoxide, at least one portion of which product can be conducted via the compressor and can be fed at an increased pressure to the membrane separating device in order to obtain a retentate which is enriched in carbon monoxide and depleted of carbon dioxide compared with the electrolysis product, wherein the device has an isolation device with at least one valve with which the electrolyzer can be completely isolated from the membrane separating device in terms of flow when changing from normal to standby operation, while largely maintaining the pressure ratios in the membrane separating device.

6. The device according to claim 5, wherein the isolation device comprises several valves, as well as a first and a second line for connecting the membrane separating device to the compressor to form a sealed-in system, in which the suction side of the compressor is connected to the permeate side of the membrane separating device via the first line and is connected to the pressure side of the compressor or the retentate side of the membrane separating device via the second line, wherein, in the second line, a control device is arranged, via which the differential pressure between retentate and permeate side of the membrane separating device can be controlled when changing the operating mode.

7. The device according to claim 5, wherein the device has a mixing device, arranged upstream of the electrolyzer and connected to the permeate side of the membrane separating device in terms of flow, in which a raw product containing carbon dioxide can be mixed with at least one portion of the permeate obtained in membrane separating device to form the electrolysis raw product, wherein the fluidic connection existing between the permeate side of the membrane separating device and the mixing device comprises a valve, belonging to the isolation device, which is open during normal operation of the device and is closed in standby operation.

8. The device according to claim 5, wherein the electrolyzer is a high-temperature or low-temperature electrolyzer designed to electrochemically convert carbon dioxide—alone or together with water—to hydrogen and/or carbon monoxide.
